(19) United States
(12) Patent Application Publication
(10) Pub. No.: US 2017/0110254 A1
(43) Pub. Date: Apr. 20, 2017

(54) WINDING-TYPE SOLID ELECTROLYTIC CAPACITOR AND WINDING-TYPE CAPACITOR ELEMENT THEREOF

(71) Applicant: APAQ TECHNOLOGY CO., LTD., MIAOLI COUNTY (TW)

(72) Inventors: MING-GOO CHIEN, TAICHUNG CITY (TW); MING-TSUNG LIANG, NEW TAIPEI CITY (TW)

(21) Appl. No.: 15/158,903

(22) Filed: May 19, 2016

(30) Foreign Application Priority Data
Oct. 14, 2015 (TW) 104133682

(51) Int. Cl. H01G 9/048; H01G 9/025; H01G 9/042; H01G 9/08; H01G 9/012

(52) U.S. Cl. CPC H01G 9/048; H01G 9/08; H01G 9/012; H01G 9/042; H01G 9/025

(57) ABSTRACT

Disclosed is a winding-type solid electrolytic capacitor which includes an enclosing casing and a winding-type capacitor element enclosed by the enclosing casing. The winding-type capacitor element includes a winding body, a positive conductive lead pin extended from a first lateral side of the winding body, and a negative conductive lead pin extended from a second lateral side of the winding body, characterized in that at least one of the positive conductive lead pin and the negative conductive lead pin is a multi-layered structure which includes an iron core and a copper or copper alloy cladding layer surrounding the iron core. Thereby, the winding-type solid electrolytic capacitor has a relatively low equivalent series resistance (ESR) and good electron-transporting ability.

### BACKGROUND OF THE INVENTION

1. Field of the Invention

The instant disclosure relates to a solid electrolytic capacitor; in particular, to a winding-type capacitor element having improved conductive pins and a winding-type solid electrolytic capacitor using the same.

2. Description of Related Art

With the rapid advancement of semiconductor processing technology, packaged electronic products follow the trend of miniaturization, high electrical performance, multi-functions, high reliability, and RoHS Compliance. The wet electrolytic capacitor could not accommodate the requirements of these electronic products, thus, the solid state electrolytic capacitor was developed.

The solid electrolytic capacitor is one of the most common passive elements, and especially the most popular passive element that can be used in electric products. The solid electrolytic capacitor, as is well known in the art, includes an anode, a cathode, and conductive lead pins respectively connected to the anode and the cathode. When the solid electrolytic capacitor is mounted on a circuit board, a resistance difference is always produced in the circuit board, thus causing loss of lifetime and heat accumulation upon a ripple current flowing through the circuit board.

The common conductive lead pins are generally made of copper, silver, or tin-coated copper-clad steel. Although a conductive lead pin made of copper has a relatively low resistance ranging from 6 mΩ to 7 mΩ, the conductive lead pin having bad mechanical strength is softened after heat treatment. Moreover, the price of the conductive lead pin made of copper or silver may be 30 to 60 percent more expensive than the conductive lead pin made of a noble metal. In addition, the conductive lead pin made of tin-coated copper-clad steel has a relatively high resistance ranging from 7 mΩ to 8 mΩ, so that it cannot meet the requirements of low resistance. There is an urgent need of for a technology to reduce the production cost and enhance the properties of the solid electrolytic capacitor.

### SUMMARY OF THE INVENTION

The object of the instant disclosure is to provide a winding-type capacitor element having an improved positive or negative conductive pin and a winding-type solid electrolytic capacitor using the same. The improved positive or negative conductive pin has good electrical conductivity that is adapted to overcome the problem of an insulation resistance.

In order to achieve the aforementioned objects, according to a preferred embodiment of the instant disclosure, the improved structure of winding-type capacitor element includes a winding body, a positive conductive lead pin extended from a first lateral side of the winding body, and a negative conductive lead pin extended from a second lateral side of the winding body, characterized in that at least one of the positive conductive lead pin and the negative conductive lead pin is a multi-layered structure which comprises an iron core and a copper or copper alloy cladding layer surrounding the iron core.

In order to achieve the aforementioned objects, according to a preferred embodiment of the instant disclosure, the winding-type solid electrolytic capacitor includes an enclosing casing and a winding-type capacitor element enclosed by the enclosing casing. The winding-type capacitor element includes a winding body, a positive conductive lead pin extended from a first lateral side of the winding body, and a negative conductive lead pin extended from a second lateral side of the winding body, characterized in that at least one of the positive conductive lead pin and the negative conductive lead pin is a multi-layered structure which includes an iron core and a copper or copper alloy cladding layer surrounding the iron core.

The benefits of the present invention include: the winding-type solid electrolytic capacitor having the multi-layered structure of the positive or negative conductive lead pin has the advantages of high electrical conductivity, good flexibility, good solderability, high magnetic conductivity, good weldability of aluminum, and good manufacturability of welding wire. Thereby, the winding-type solid electrolytic capacitor has a relatively low equivalent series resistance (ESR) and good electron-transporting ability. Moreover, the winding-type solid electrolytic capacitor has good mechanical and electrical connection, and its production cost can be reduced.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is a schematic diagram of the winding-type solid electrolytic capacitor of the present invention;

FIG. 2 is a schematic diagram of the winding-type capacitor element of the present invention;

FIG. 3 is a cross-sectional diagram of the positive or negative conductive lead pin of the winding-type capacitor element of the present invention;

FIGS. 4 to 6 are schematic diagrams illustrating a riveting method of the positive and negative conductive lead pins.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

Because the reliability of an aluminum electrolytic capacitor is related to the impedance of at least one conductive pin, the present invention relates to an improved structure of a positive or negative conductive pin with high electrical conductivity. This results in good electrical properties for an aluminum electrolytic capacitor. Moreover, the aluminum electrolytic capacitor is provided with wide applicability and has the advantage of low cost and high yield based on the improved structure of a positive or negative conductive pin.

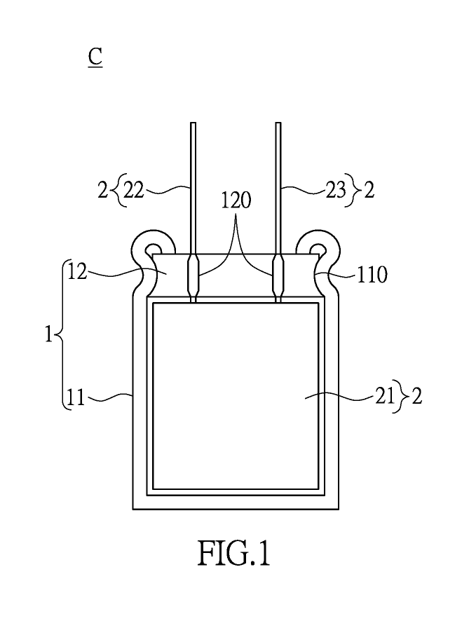

Please refer to FIG. 1, which is a schematic diagram of a winding-type solid electrolytic capacitor according a preferred embodiment of the present invention. The winding-type solid electrolytic capacitor C is a solid aluminum electrolytic capacitor which includes an enclosing casing 1 and a winding-type capacitor element 2. The winding-type capacitor element 2 is enclosed by the enclosing casing 1 and includes a winding body 21, a positive conductive lead pin 22 extended from a first lateral side of the winding body 21, and a negative conductive lead pin 23 extended from a second lateral side of the winding body 21.

Specifically, the enclosing casing 1 includes an outer case 11 and a sealed cap 12. The outer case 11 can be made of aluminum or any other suitable packaging material. The sealed cap 12 can be made by filling or injecting a composite containing a thermosetting, UV curable, or catalyst curable resin to an opening 111 of the outer case 11. The sealed cap 12 has two lead holes 120 formed by punching or machining An end portion of the positive conductive lead pin 22 and an end portion of the negative conductive lead pin 23 serving as outer conductive contacts are respectively exposed from the lead holes 120. However, there is no particular restriction on the shape and size of the lead holes 120. The lead holes 120 are designed in relation to the relative positive and negative conductive lead pins 22, 23.

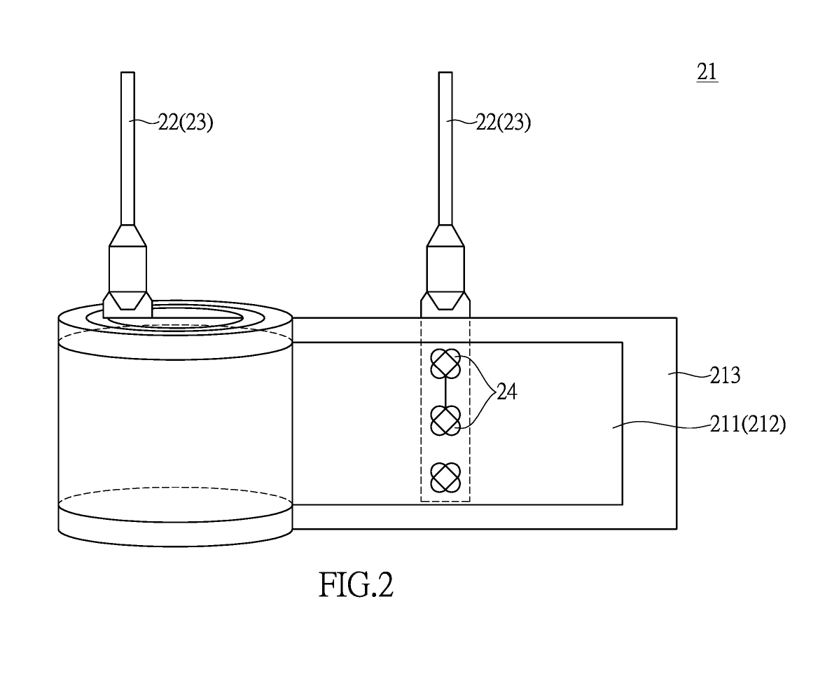

Please refer to FIGS. 1 and 2, wherein FIG. 2 is a schematic diagram of the winding-type capacitor element according a preferred embodiment of the present invention. The winding body 21, as shown in FIG. 2, is made by rolling together a positive foil 211, a negative foil 212, and an electrolytic paper 213 disposed between the positive foil 211 and the negative foil 212 into a cylindrical shape. However, there is no particular restriction on the shape of the winding body 21. In various embodiments, the cylindrical winding body 21 can be pressed into a rectangular shape under a temperature of 50° C. to 300° C.

Specifically, the positive conductive lead pin 22 is disposed between the positive foil 211 and the electrolytic paper 213. The negative conductive lead pin 23 is disposed between the negative foil 212 and the electrolytic paper 213. The positive and negative conductive lead pins 22, 23 respectively contact the positive and negative foils 211, 212. Preferably, the positive and negative conductive lead pins 22, 23 are respectively riveted to the positive and negative foils 211, 212 to ensure good mechanical and electrical connection between the positive conductive lead pin 22 and the positive foil 211 and between the negative conductive lead pin 23 and the negative foil 212.

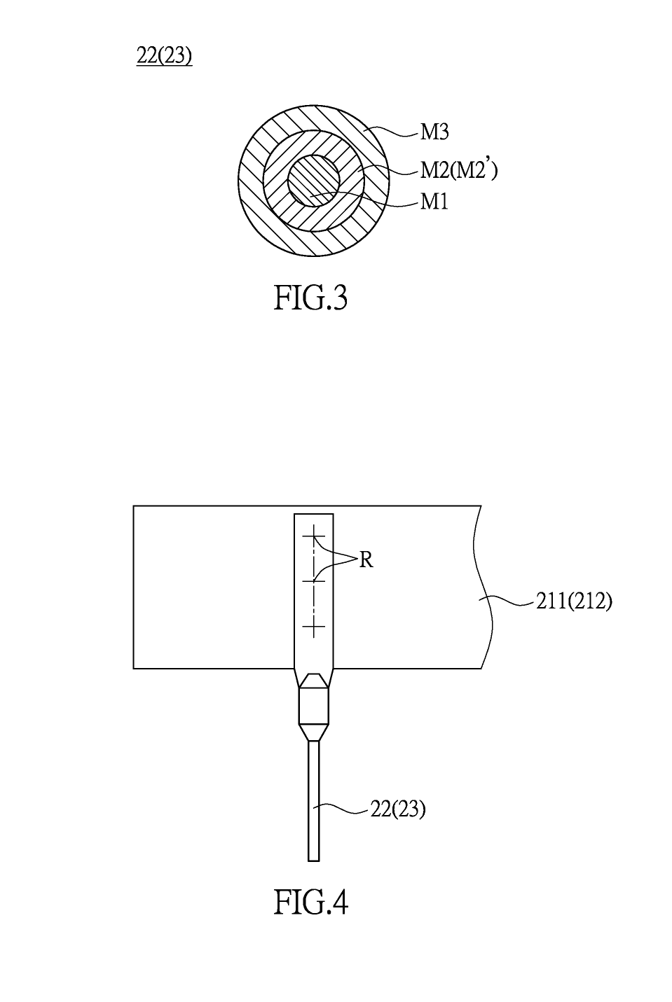

Please refer to FIG. 3. At least one of the positive conductive lead pin 22 and the negative conductive lead pin 23 is a multi-layered structure which includes an iron core M1 and a copper cladding layer M2 or copper alloy cladding layer M2′ surrounding the iron core M1. For the instant embodiment, the copper cladding layer M2 or copper alloy cladding layer M2′ can be formed by chemical plating or electroplating, wherein the copper alloy cladding layer M2′ can be made of copper-silver alloy or copper-nickel alloy. The copper-silver alloy includes silver from 1 wt % to 3 wt %, and the copper-nickel alloy includes nickel from 1 wt % to 3 wt %. Preferably, the multi-layered structure of the positive or negative conductive lead pin 22, 23 further includes a tin cladding layer M3 surrounding the copper cladding layer M2 or copper alloy cladding layer M2′. The tin cladding layer M3 can be formed by chemical plating or electroplating.

Because the multi-layered structure of the positive or negative conductive lead pin 22, 23 has the advantages of high electrical conductivity, good flexibility, good solderability, high magnetic conductivity, good weldability of aluminum, and good manufacturability of welding wire, the resulting winding-type solid electrolytic capacitor C has good mechanical and electrical properties, and its production cost can be reduced. Moreover, by improving the material of the positive or negative conductive lead pin 22, 23, the winding-type solid electrolytic capacitor C has a relatively low equivalent series resistance (ESR) that is less than 12.0 mΩ, and its ripple eliminating ability can be increased. According to the results shown in Table 1, compared with conventional capacitors having a high ESR in the range from 11 mΩ to 14 mΩ, the winding-type solid electrolytic capacitor C can exhibit a relatively low ESR in the range from 6 mΩ to 12 mΩ.

TABLE 1

| ESR values | | winding-type solid |
|---|---|---|
| (mΩ) | conventional capacitor | electrolytic capacitor |
| <5 | 2.9 | 1.0 |
| 5-6 | 0 | 0 |
| 6-7 | 0 | 0 |
| 7-8 | 0 | 0 |
| 8-9 | 0 | 4.6 |
| 9-10 | 0.1 | 25.0 |
| 10-11 | 4.4 | 35.0 |
| 11-12 | 20.9 | 20.4 |
| 12-13 | 31.1 | 7.7 |
| 13-14 | 21.7 | 2.9 |
| 14-15 | 10.3 | 1.0 |
| 15-16 | 3.9 | 0.5 |
| 16-17 | 1.4 | 0.2 |
| 17-18 | 0.6 | 0.2 |
| 18-19 | 0.4 | 0.1 |
| 19-20 | 0.2 | 0.6 |
| 20-50 | 0.8 | 0.6 |
| 50-100 | 0.2 | 0.1 |
| >100 | 1.2 | 0.3 |
| Total | 100 | 100 |

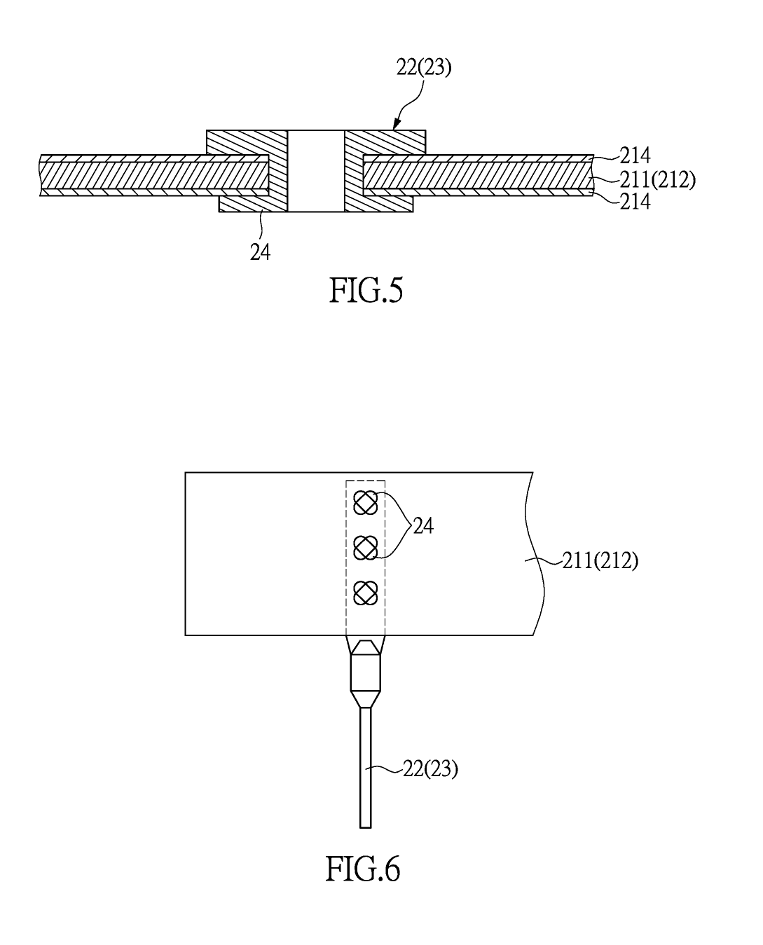

Please refer to FIGS. 4 to 6. The features and advantages of the winding-type solid electrolytic capacitor C are mentioned above. The following will describe a riveting method of the positive and negative conductive lead pins 22, 23.

Referring to FIG. 4, the first step of the riveting method is to dispose the positive conductive lead pin 22 between the positive foil 211 and the electrolytic paper 213, and dispose the negative conductive lead pin 23 between the negative foil 212 and the electrolytic paper 213. At least one target region R of the positive conductive lead pin 22 fittingly abut an oxide film 214 formed on the surface of the positive foil 211. At least one target region R of the negative conductive lead pin 23 fittingly abut an oxide film 214 formed on the surface of the negative foil 212. In practice, the positive and negative conductive lead pins 22, 23 can be disposed by a clamping mechanism, but the present invention is not restricted thereto.

Referring to FIGS. 5 and 6, the next step of the riveting method is to punch the positive and negative conductive lead pins 22, 23, and then to flatten their punched-out parts 24. In practice, an impact force provided by a riveting mechanism is applied to the target regions R to perforate parts of the positive and negative conductive lead pins 22, 23, and all the parts in the target regions R are punched out from the positive and negative conductive lead pins 22, 23, wherein the punched-out parts 24 are formed with a curvature. After that, the punched-out parts 24 are flattened by a flattening mechanism, wherein each of the curved punched-out parts 24 having a relatively large contact area can be easily flattened to abut against the bottom side of the positive or negative conductive lead pin 22, 23.

Please note that because each of the punched-out parts 24 can be totally flattened to abut against the bottom side of the positive or negative conductive lead pin 22, 23, there is no gap between the positive conductive lead pin 22 and the positive foil 211, and there is no gap between the negative conductive lead pin 23 and the negative foil 212. Moreover, the punched-out parts 24 can be flattened without any fracture. The punched-out parts 24 have the same size and shape, and are arranged at intervals along the thickness direction of the positive or negative conductive lead pin 22, 23.

Based on the above, the winding-type solid electrolytic capacitor having the multi-layered structure of the positive or negative conductive lead pin has the advantages of high electrical conductivity, good flexibility, good solderability, high magnetic conductivity, good weldability of aluminum, and good manufacturability of welding wire. Thereby, the winding-type solid electrolytic capacitor has a relatively low equivalent series resistance (ESR) and good electron-transporting ability.

Moreover, the winding-type solid electrolytic capacitor has good mechanical and electrical connection, and its production cost can be reduced.

In addition, by using the riveting method of the instant disclosure, the punched-out parts can be totally flattened to abut against the bottom side of the positive or negative conductive lead pin without fractures. The punched-out parts have the same size and shape, and are arranged at intervals along the thickness direction of the positive or negative conductive lead pin. Thereby, good electrical connections between the positive conductive lead pin and the positive foil and between the negative conductive lead pin and the negative foil can be achieved.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. An improved structure of winding-type capacitor element, comprising a winding body, a positive conductive lead pin extended from a first lateral side of the winding body, and a negative conductive lead pin extended from a second lateral side of the winding body, characterized in that at least one of the positive conductive lead pin and the negative conductive lead pin is a multi-layered structure which comprises an iron core and a copper or copper alloy cladding layer surrounding the iron core.

2. The improved structure according to claim 1, wherein the copper alloy cladding layer is made of copper-silver alloy which comprises silver from 1 wt % to 3 wt %.

3. The improved structure according to claim 1, wherein the copper alloy cladding layer is made of copper-nickel alloy which comprises nickel from 1 wt % to 3 wt %.

4. The improved structure according to claim 2, wherein the multi-layered structure further comprises a tin or tin alloy cladding layer surrounding the copper or copper alloy cladding layer.

5. The improved structure according to claim 3, wherein the multi-layered structure further comprises a tin or tin alloy cladding layer surrounding the copper or copper alloy cladding layer.

6. The improved structure according to claim 1, wherein the winding body comprises a positive foil, a negative foil, and an electrolytic paper disposed between the positive foil and the negative foil, and the positive conductive lead pin and the negative conductive lead pin are mounted on the positive foil and the negative foil respectively.

7. A winding-type solid electrolytic capacitor, comprising:
an enclosing casing;
a winding-type capacitor element enclosed by the enclosing casing, comprising a winding body, a positive conductive lead pin extended from a first lateral side of the winding body, and a negative conductive lead pin extended from a second lateral side of the winding body, characterized in that at least one of the positive conductive lead pin and the negative conductive lead pin is a multi-layered structure which comprises an iron core and a copper or copper alloy cladding layer surrounding the iron core.

8. The winding-type solid electrolytic capacitor according to claim 7, wherein the copper alloy cladding layer is made of copper-silver alloy which comprises silver from 1 wt % to 3 wt %.

9. The winding-type solid electrolytic capacitor according to claim 7, wherein the copper alloy cladding layer is made of copper-nickel alloy which comprises nickel from 1 wt % to 3 wt %.

10. The winding-type solid electrolytic capacitor according to claim 8, wherein the multi-layered structure further comprises a tin or tin alloy cladding layer surrounding the copper or copper alloy cladding layer.

11. The winding-type solid electrolytic capacitor according to claim 9, wherein the multi-layered structure further comprises a tin or tin alloy cladding layer surrounding the copper or copper alloy cladding layer.

12. The winding-type solid electrolytic capacitor according to claim 7, wherein the winding body comprises a positive foil, a negative foil, and an electrolytic paper disposed between the positive foil and the negative foil, and the positive conductive lead pin and the negative conductive lead pin are mounted on the positive foil and the negative foil respectively.

13. The winding-type solid electrolytic capacitor according to claim 7, wherein the enclosing casing comprises an outer case and a sealed cap installed over an opening of the outer case, the sealed cap is provided with two lead holes, and an end portion of the positive conductive lead pin and an end portion of the negative conductive lead pin serving as outer conductive contacts are respectively exposed from the lead holes.
